(19) United States
(12) Patent Application Publication
(10) Pub. No.: US 2019/0056021 A1
(43) Pub. Date: Feb. 21, 2019

(54) DAMPER PULLEY FOR VEHICLE

(71) Applicants: Hyundai Motor Company, Seoul (KR); Kia Motors Corporation, Seoul (KR)

(72) Inventor: Jong Won Lee, Hwaseong (KR)

(21) Appl. No.: 15/831,089

(22) Filed: Dec. 4, 2017

(30) Foreign Application Priority Data
Aug. 17, 2017 (KR) 10-2017-0104236

(51) Int. Cl. F16H 55/36; F16D 13/76; F16D 27/04

(52) U.S. Cl. CPC F16H 55/36; F16D 13/76; F16D 27/04; B60Y 2400/48; B60Y 2200/92; Y10S 903/904; F16H 2055/366

(57) ABSTRACT

A damper pulley for a hybrid vehicle with a mild hybrid starter and generator (MHSG) includes: a crank adapter coupled to a crankshaft that is rotated by a driving torque of an engine of the hybrid vehicle; a clutch having a surface mounted on the crank adapter; a pulley body having an interior circumference to which a pulley adapter is coupled; and a bearing interposed between an exterior circumference of the crank adapter and the interior circumference of the pulley body and disposed so as to enable the pulley body to be freely rotatable. The clutch connects the crankshaft to the pulley body through the pulley adapter during an operation condition of the engine, and the clutch releases the connection of the crankshaft to the pulley body through the pulley adapter during the stopping condition of the engine.

### CROSS-REFERENCE TO RELATED APPLICATION

This application claims the benefit of priority to Korean Patent Application No. 10-2017-0104236 filed in the Korean Intellectual Property Office on Aug. 17, 2017, the entire contents of which are incorporated by reference as if fully set forth herein.

### BACKGROUND OF THE DISCLOSURE

### (a) Technical Field

The present disclosure relates to a damper pulley for a vehicle. More particularly, the present disclosure relates to a damper pulley for a vehicle selectively connected to a crankshaft depending on an operation of an engine in a hybrid vehicle that applies a mild hybrid starter and generator (MHSG).

### (b) Description of the Related Art

In most vehicles, a damper pulley is directly fitted on a crankshaft such that the damper pulley directly receives torque from the crankshaft as it is rotated by an engine. The damper pulley serves to transmit the rotational driving torque of the engine transmitted to the crankshaft to various accessory elements such as a water pump, a power steering device, an air conditioner, etc.

The damper pulley is typically formed by combining a hub part, which is fitted on the crankshaft, with a pulley part, which rotates with the hub and is connected with a power transmission member. The hub part and the pulley part may be bolted. The damper pulley is also connected to the accessory elements through a belt to transmit the driving torque of the engine to the accessory elements.

Nowadays, as interest in energy efficiency and reducing environmental pollution increases, environmentally-friendly vehicles that can substantially replace an internal combustion engine vehicle are being developed. These vehicles generally include electric vehicles that are driven using a fuel cell or electricity as a power source and hybrid vehicles that are driven using an engine and an electric battery.

In a hybrid vehicle, the engine is selectively stopped depending on the driving condition, and the conventional damper pulley that is integrally connected to the crankshaft is applied. However, if driving torque is required for operating the accessory elements while the engine of the hybrid vehicle is intended to stop, a problem arises in that unnecessary fuel is consumed and the engine stop section is reduced because the engine is forced to operate so as to rotate the damper pulley.

The above information disclosed in this Background section is only for enhancement of understanding of the background of the disclosure, and therefore it may contain information that does not form the related art.

### SUMMARY OF THE DISCLOSURE

Accordingly, the present disclosure provides a damper pulley for a hybrid vehicle applying a mild hybrid starter and generator (MHSG) that is selectively connected to the crankshaft depending on an operation condition of the engine. The damper pulley can operate the accessory elements using the driving torque of the MHSG during a stopping condition of the engine so as to prevent unnecessary fuel consumption.

According to embodiments of the present disclosure, a damper pulley for a hybrid vehicle with a mild hybrid starter and generator (MHSG) includes: a crank adapter coupled to a crankshaft that is rotated by a driving torque of an engine of the hybrid vehicle; a clutch having a surface mounted on the crank adapter; a pulley body having an interior circumference to which a pulley adapter is coupled; and a bearing interposed between an exterior circumference of the crank adapter and the interior circumference of the pulley body and disposed so as to enable the pulley body to be freely rotatable. The clutch connects the crankshaft to the pulley body through the pulley adapter during an operation condition of the engine, and the clutch releases the connection of the crankshaft to the pulley body through the pulley adapter during the stopping condition of the engine.

The pulley adapter may be disposed to be separated from the clutch by a predetermined gap, and the pulley body may be selectively coupled to the clutch to be integrally rotated with the crankshaft based on an operation of the clutch.

The operation condition of the engine may be one of: an engine starting operation, a torque assisting operation, and a regenerative braking operation.

During the stopping condition of the engine, a driving torque of the MHSG may be transmitted to an accessory element through an operation of the MHSG if driving torque is required to operate the accessory element.

The clutch may be a magnetic clutch that is electrically connected to a controller and configured to generate an electromagnetic force according to a control signal generated by the controller.

The pulley body may include: a flange part having an interior circumference coupled to an exterior circumference of the bearing and mounted to the pulley adapter; a damper part coupled to an exterior circumference of the flange part; and a belt connection part having an interior circumference coupled to an exterior circumference of the damper part and having an exterior circumference on which a belt groove is formed.

The crank adapter may include a mounting groove in which the crankshaft is inserted.

The crank adapter may be coupled to the crankshaft through a mounting bolt when the crankshaft is inserted in the mounting groove.

As described above, as the MHSG of a hybrid vehicle is selectively connected to the crankshaft according to an operation condition of the engine, accessory elements in the vehicle are operated by the driving torque of the MHSG during a stopping condition of engine, thereby preventing the unnecessary fuel consumption.

Also, as the damper pulley according to embodiments of the present disclosure is freely rotated in the connection release state with the crankshaft during the engine stopping condition, the driving torque of the MHSG may be smoothly transmitted to the accessory elements, and the stopping period of the engine may increase, thereby enhancing fuel efficiency of the vehicle.

### BRIEF DESCRIPTION OF THE DRAWINGS

The embodiments herein may be better understood by referring to the following description in conjunction with the accompanying drawings, briefly described below, in which like reference numerals indicate identically or functionally similar elements.

FIG. 1 is a view showing connection of a damper pulley for a vehicle and accessory elements according to embodiments of the present disclosure.

FIG. 2 is a cross-sectional view of a damper pulley for a vehicle according to embodiments of the present disclosure.

FIG. 3 is an operation diagram of a damper pulley for a vehicle according to embodiments of the present disclosure.

FIG. 4 is a graph showing a engine operation condition and an engine stopping condition in a hybrid vehicle applying a damper pulley for a vehicle according to embodiments of the present disclosure.

FIG. 5 is a view showing operations of a damper pulley for a vehicle and accessory elements according to embodiments of the present disclosure in an operation condition of an engine.

FIG. 6 is a view showing operations of a damper pulley for a vehicle and accessory elements according to embodiments of the present disclosure in a stopping condition of an engine.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DESCRIPTION OF SYMBOLS

100: damper pulley
102: crankshaft
104: crank adapter
106: mounting groove
108: clutch
110: pulley body
112: pulley adapter
114: flange part
116: damper part
118: belt connection part
120: bearing
130: controller
140: mounting bolt
150: washer

### DETAILED DESCRIPTION OF THE EMBODIMENTS

Embodiments of the present disclosure will hereinafter be described in detail with reference to the accompanying drawings. Configurations illustrated in the embodiments and the drawings described in the present specification are only certain embodiments of the present disclosure and do not represent all of the technical spirit of the present disclosure. Thus, it is to be understood that various modified examples, which may replace the configurations, are possible when filing the present application.

In order to clearly describe the present disclosure, parts that are irrelevant to the description are omitted, and identical or similar constituent elements throughout the specification are denoted by the same reference numerals. Since the size and thickness of each configuration shown in the drawings are arbitrarily shown for convenience of description, the present disclosure is not necessarily limited to configurations illustrated in the drawings, and in order to clearly illustrate several parts and areas, enlarged thicknesses are shown.

Moreover, throughout the specification, unless explicitly described to the contrary, the word “comprise” and variations such as “comprises” or “comprising” will be understood to imply the inclusion of stated elements but not the exclusion of any other elements. Furthermore, terms such as “ . . . unit”, “ . . . means”, “ . . . part”, and “ . . . member” described in the specification mean a unit of a comprehensive configuration having at least one function or operation.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the controller in conjunction with one or more other components, as would be appreciated by a person of ordinary skill in the art.

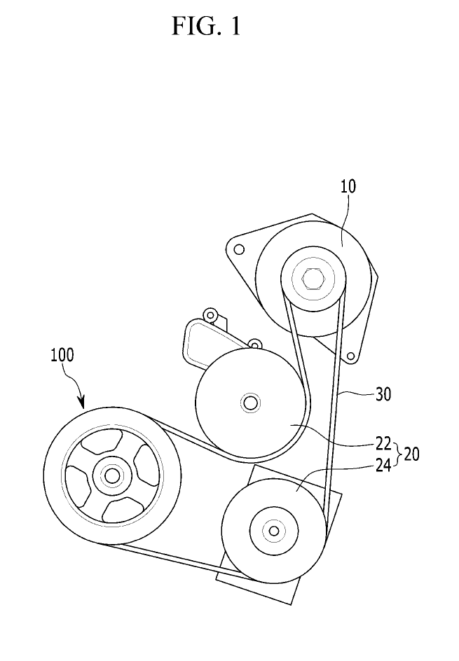

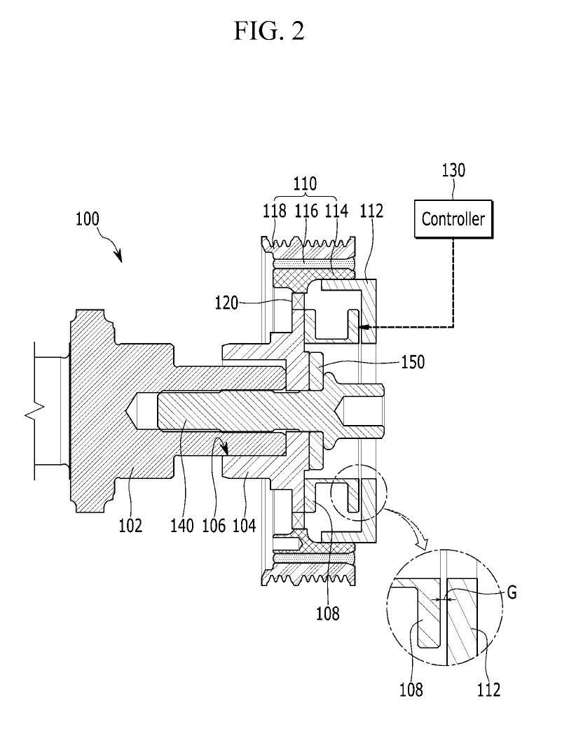

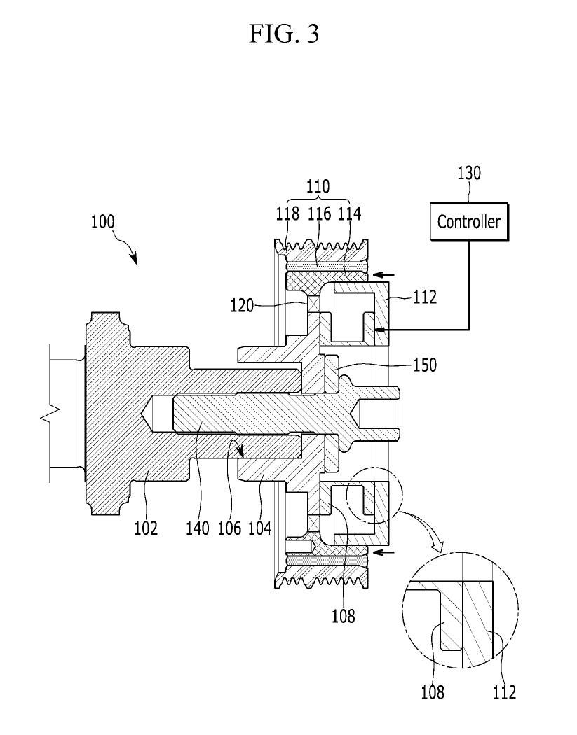

Referring now to embodiments of the present disclosure, FIG. 1 is a view showing connection of a damper pulley for a vehicle and accessory elements according to embodiments of the present disclosure, FIG. 2 is a cross-sectional view of a damper pulley for a vehicle according to embodiments of the present disclosure, and FIG. 3 is an operation diagram of a damper pulley for a vehicle according to embodiments of the present disclosure.

As shown in FIG. 1, a damper pulley 100 for a vehicle according to embodiments of the present disclosure is applied to a hybrid vehicle having a mild hybrid starter and generator (MHSG) 10 and an engine (not shown). The damper pulley 100 transmits a rotational driving torque of the engine to an accessory element 20, such as a water pump 22, an air conditioner compressor 24, or the like. The damper pulley 100 is mutually connected to the MHSG 10 and the accessory elements 20 (including the water pump 22, the air conditioner compressor 24, etc.) through a belt 30. The damper pulley 100 is mounted to a crankshaft 102 provided at a cylinder block, causing the engine to transmit the rotational driving torque resulting from operation of the engine to another element of the vehicle (e.g., an accessory element 20).

As shown in FIG. 2, the damper pulley 100 includes a crank adapter 104, a clutch 108, a pulley body 110, and a bearing 120. The crank adapter 104 is coupled to the crankshaft 102 such that they are integrally rotated.

The crank adapter 104 includes a mounting groove 106 in which the crankshaft 102 is inserted. The crank adapter 104 may be coupled to the crankshaft 102 through a mounting bolt 140 when the crankshaft 102 is inserted to the mounting groove 106. A washer 150 may be provided between the mounting bolt 140 and the crank adapter 104.

According to embodiments of the present disclosure, one surface of the clutch 108 is mounted on the crank adapter 104. The clutch 108 is electrically connected to the controller 130 and may be a magnetic clutch which generates an electromagnetic force according to a control signal generated by the controller 130.

A pulley adapter 112 is coupled to an interior circumference of the pulley body 110. Also, the bearing 120 is disposed between the exterior circumference of the crank adapter 104 and the interior circumference of the pulley body 110 and may support the pulley body 110 to be freely rotatable from the crank adapter 104.

The pulley adapter 112 is disposed so as to be separated from the clutch 108 by a predetermined gap G. The pulley adapter 112 may be selectively coupled to the clutch 108 according to the operation of the clutch 108 so that the pulley body 110 is integrally rotated with the crankshaft 102. That is, the clutch 108 is operated depending on the control signal of the controller 130 indicating the operation condition of the engine, thereby coupling the crankshaft 102 and the pulley body 110 through the pulley adapter 112.

In contrast, the clutch 108 is operated depending on the control signal of the controller 130 so as to release the coupling of the crankshaft 102 and the pulley body 110 in a stopping condition of the engine (e.g., when the engine stops), thereby releasing the connected with the pulley adapter 112. The pulley body 110 may include, for example, a flange part 114, a damper part 116, and a belt connection part 118. The interior circumference of the flange part 114 is coupled to the exterior circumference of the bearing 120.

The damper part 116 is generally formed of a rubber material to absorb a vibration or an impact to be reduced. The damper part 116 is coupled on the exterior circumference of the flange part 114. Also, the interior circumference of the belt connection part 118 is coupled on the exterior circumference of the damper part 116, and a belt groove 118a may be formed on the exterior circumference so that the belt 30 is rolled to be mounted.

The operation of the above-configured damper pulley 100 will be described with reference to FIG. 3.

As shown in FIG. 3, the controller 130 applies a control signal to the clutch 108 based on the operation condition of the engine. Thus, the clutch 108 generates the electromagnetic force in response to the control signal of the controller 130.

When the pulley adapter 112 is coupled to the pulley body 110, the pulley adapter 112 moves to the clutch 108 side by the electromagnetic force of the clutch 108 and contacts the clutch 108 while the predetermined gap G if offset. Accordingly, the pulley body 110 is integrally combined to the crankshaft 102 and is integrally rotated with the crankshaft rotated by the driving torque of the engine.

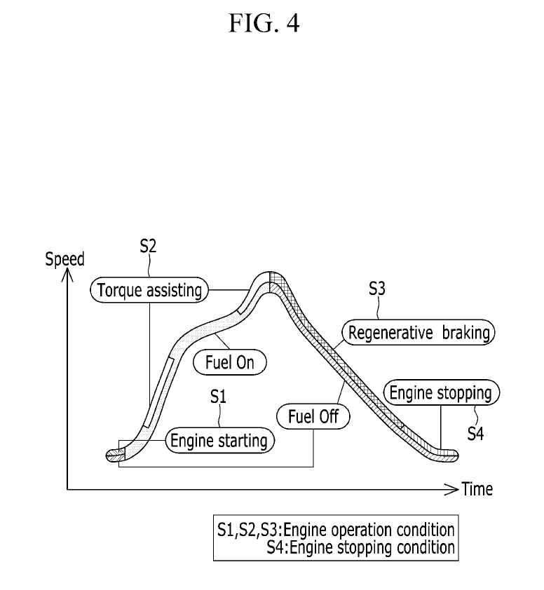

The operation condition of the engine and the stopping condition of the engine in the hybrid vehicle to which the damper pulley 100 is applied will be described with reference to FIG. 4.

FIG. 4 is a graph showing an engine operation condition and an engine stopping condition in a hybrid vehicle applying a damper pulley for a vehicle according to embodiments of the present disclosure.

As shown in FIG. 4, the operation condition of the engine may be any one of, for instance, an engine starting step S1, a torque assisting step S2, and a regenerative braking step S3. Meanwhile, the stopping condition of the engine may be a condition in which the vehicle stops for a certain period of time while the vehicle is in operation, or such as a parking that the operation of the vehicle is interrupted, and may include an engine stopping step S4.

The torque assisting step S2 and the regenerative braking step S3 are states in which fuel is supplied to the engine, and the engine starting step S1 and the engine stopping step S4 are states in which fuel is not supplied to the engine. That is, during an operation condition of the engine, the damper pulley 100 is connected to the crankshaft 102 to receive the rotation driving torque of the engine through the crankshaft 102. In contrast, the damper pulley 100 may be freely rotated in the state that the connection with the crankshaft 102 is released during a stopping condition of the engine.

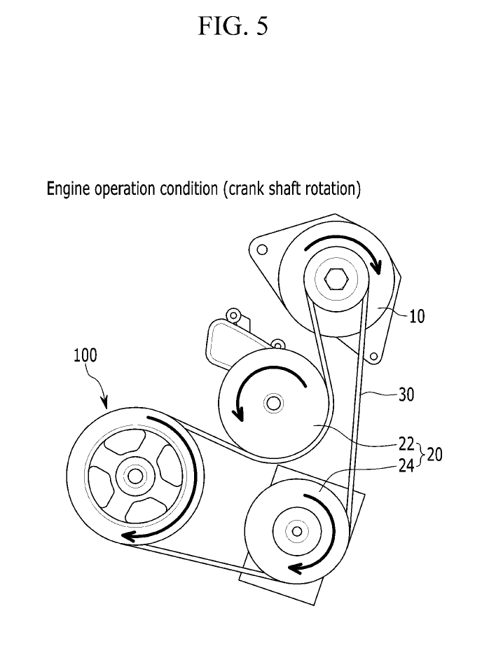

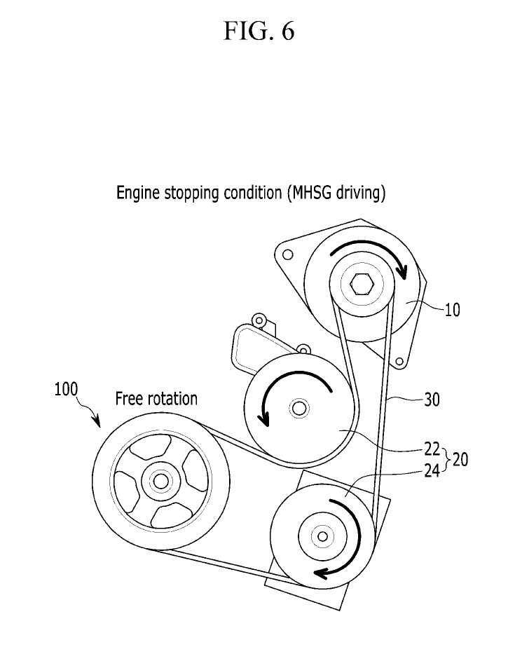

In the vehicle to which the damper pulley 100 is applied, the case that the driving torque is required to the accessory elements 20 will be described according to the operation condition of the engine or the stopping condition of the engine with reference to FIG. 5 and FIG. 6.

FIG. 5 is a view showing operations of a damper pulley for a vehicle and accessory elements according to embodiments of the present disclosure in an operation condition of an engine, and FIG. 6 is a view showing operations of a damper pulley for a vehicle and accessory elements according to embodiments of the present disclosure in a stopping condition of an engine.

First, in the operation condition of the engine, the clutch 108 is operated by the control signal applied from the controller 130 to generate the electromagnetic force. Thus, the pulley adapter 112 moves to the clutch 108 side by the electromagnetic force of the clutch 108 in the state that the pulley adapter 112 is coupled with the pulley body 110 and is in contact with the clutch 108 while the predetermined gap G, thereby the pulley body 110 is integrally combined to the crankshaft 102. Accordingly, the damper pulley 100 is integrally rotated with the crankshaft rotated by the driving torque of the engine (referring to FIG. 3).

In this state, if the driving torque is required to the accessory elements 20, as shown in FIG. 5, while the damper pulley 100 is integrally rotated with the crankshaft 102 rotated by the rotation driving torque of the engine, the damper pulley 100 transmits the driving torque to the accessory elements 20 through the belt 30. In contrast, during the stopping condition of the engine, the operation of the clutch 108 is stopped by the control signal applied from the controller 130 such that the generation of the electromagnetic force is stopped. Thus, as shown in FIG. 2, while the contact with the clutch 108 is released, the predetermined gap G is formed between the pulley adapter 112 and the clutch 108. Accordingly, the combination of the damper pulley 100 and the crankshaft 102 is released and the damper pulley 100 may be freely rotated separately from the crankshaft 102 by the bearing 120.

In this state, if the driving torque is required to the accessory elements 20, as shown in FIG. 6, the MHSG 10 is operated such that the driving torque of the MHSG 10 is transmitted to the accessory elements 20 through the belt 30. As the damper pulley 100 is freely rotated, the driving torque of the MHSG 10 may be smoothly transmitted to the accessory elements 20. That is, during the engine stopping condition, as the driving torque for the operation of the accessory elements 20 is supplied from the MHSG 10, unnecessary operation of the engine may be prevented.

Accordingly, if the above-configured damper pulley for the vehicle 100 according to embodiments of the present disclosure is applied, as the damper pulley 100 is selectively connected to the crankshaft 102 according to the operation condition of the engine in the hybrid vehicle including the MHSG 10, the accessory elements 20 are operated by the driving torque of the MHSG 10 without operation of the engine during the stopping condition of engine, thereby preventing the unnecessary fuel consumption.

Also, as the damper pulley for the vehicle 100 according to embodiments of the present disclosure is freely rotated in the connection release state with the crankshaft 102 in the engine stopping condition, the driving torque of the MHSG 10 may be smoothly transmitted to the accessory elements 20, and the stopping period of the engine may increase, thereby enhancing fuel economy of the vehicle.

While this disclosure has been described in connection with certain embodiments, it is to be understood that the disclosure is not limited to the disclosed embodiments, but, on the contrary, is intended to cover various modifications and equivalent arrangements included within the spirit and scope of the appended claims.

What is claimed is:

1. A damper pulley for a hybrid vehicle with a mild hybrid starter and generator (MHSG), the damper pulley comprising:
a crank adapter coupled to a crankshaft that is rotated by a driving torque of an engine of the hybrid vehicle;
a clutch having a surface mounted on the crank adapter;
a pulley body having an interior circumference to which a pulley adapter is coupled; and
a bearing interposed between an exterior circumference of the crank adapter and the interior circumference of the pulley body and disposed so as to enable the pulley body to be freely rotatable, wherein
the clutch connects the crankshaft to the pulley body through the pulley adapter during an operation condition of the engine, and
the clutch releases the connection of the crankshaft to the pulley body through the pulley adapter during a stopping condition of the engine.

2. The damper pulley for the vehicle of claim 1, wherein:
the pulley adapter is disposed to be separated from the clutch by a predetermined gap, and
the pulley body is selectively coupled to the clutch to be integrally rotated with the crankshaft based on an operation of the clutch.

3. The damper pulley for the vehicle of claim 1, wherein:
the operation condition of the engine is one of: an engine starting operation, a torque assisting operation, and a regenerative braking operation.

4. The damper pulley for the vehicle of claim 1, wherein:
during the stopping condition of the engine, a driving torque of the MHSG is transmitted to an accessory element through an operation of the MHSG if driving torque is required to operate the accessory element.

5. The damper pulley for the vehicle of claim 1, wherein:
the clutch is a magnetic clutch that is electrically connected to a controller and configured to generate an electromagnetic force according to a control signal generated by the controller.

6. The damper pulley for the vehicle of claim 1, wherein the pulley body includes:
a flange part having an interior circumference coupled to an exterior circumference of the bearing and mounted to the pulley adapter; a damper part coupled to an exterior circumference of the flange part; and a belt connection part having an interior circumference coupled to an exterior circumference of the damper part and having an exterior circumference on which a belt groove is formed.

7. The damper pulley for the vehicle of claim 1, wherein:
the crank adapter includes a mounting groove in which the crankshaft is inserted.

8. The damper pulley for the vehicle of claim 7, wherein:
the crank adapter is coupled to the crankshaft through a mounting bolt when the crankshaft is inserted in the mounting groove.
